(19) United States
(12) Patent Application Publication
(10) Pub. No.: US 2019/0000121 A1
(43) Pub. Date: Jan. 3, 2019

(54) FORMULATION OF FOOD PRODUCT BASED ON GREEN BANANA FLOUR, PRODUCTION PROCESS AND ITS CORRESPONDING END PRODUCT

(71) Applicant: Samuel Schiavon De Rivas, Almirante Tamandare (BR)

(72) Inventor: Samuel Schiavon De Rivas, Almirante Tamandare (BR)

(21) Appl. No.: 15/364,717

(22) Filed: Nov. 30, 2016

(30) Foreign Application Priority Data
Jan. 25, 2016 (BR) BR 10 2016 001591

(51) Int. Cl. A23L 19/00; A23G 1/34; A23G 1/38; A23G 1/40; A23G 1/44; A23G 1/48; A23P 30/10

(52) U.S. Cl. CPC A23L 19/01; A23G 1/34; A23G 1/38; A23V 2002/00; A23G 1/44; A23G 1/48; A23P 30/10; A23G 1/40

(57) ABSTRACT

The present invention patent refers to the formulation of an optional chocolate-type food alternative, obtained from green banana flour (Musa spp) derived from green bananas or semi green ones from the plant varieties Prata, Terra, Cavendish, Nanica or Nanicão. The product presents sensory attributes (taste, colour, aroma and texture) that are similar to cocoa-based products, being presented in the form of tablets, bars, chocolates, toppings, etc. It is recommended for a public that shows dietary restrictions both from pathological and/or philosophical character, due to it containing special nutritional characteristics: the lack of lactose, sugar and cocoa. Besides, the presence of resistant starch—“RS”—and dietary fibre—“FA”—in the composition of the green banana flour present a preventive action for some non-communicable chronic diseases, which makes the product substantially different.

### TECHNICAL FIELD OF THE INVENTION

The present invention patent refers to the formulation of an optional chocolate-type food alternative, obtained from green banana flour (Musa spp) derived from green bananas or semi green ones from the plant varieties Prata, Terra, Cavendish, Nanica or Nanicão. The product presents sensory attributes (taste, colour, aroma and texture) that are similar to cocoa-based products, being presented in the form of tablets, bars, chocolates, toppings, etc.

It is recommended for a public that shows dietary restrictions both from pathological and/or philosophical character, due to it containing special nutritional characteristics: the lack of lactose, sugar and cocoa. Besides, the presence of resistant starch—“RS”- and dietary fibre —“FA”—in the composition of the green banana flour present a preventive action for some non-communicable chronic diseases, which makes the product substantially different.

### INVENTION HISTORY

The increase in demand for a healthy and functional food has encouraged the food industry to develop of products that meet this demand. The incorporation of functional components into food products is a current trend that presents a difference and broadens the consumer market. Thus, the creation of an alternative chocolate from green banana flour aims to serve the population in general, being more directed to individuals who choose a healthy diet and to those with eating disorders like: lactose intolerance, hyperglycaemia, sensitivity to caffeine and theobromine, gluten allergy and intolerance, among others.

A food can be considered functional if it is demonstrated that it can beneficially affect one or more target functions in the body, besides having adequate nutritional effects, in a way that is both relevant to the well-being and health and, also, for reducing the risk of a disease (ROBERFROID; M. Functional food concept and its application to prebiotics. Digestive and Liver Disease, v. 34, Suppl. 2, p. 105-10, 2002).

The banana represents the fourth energy source after maize, rice and wheat; it has a variable source of minerals, therefore, being an important component in the food supply of the entire world, its flavour being one of the most important quality attributes. Its high concentration of starch from the flour processing, is of an industrial purpose and of interest as a food source (BORGES, A de M.; PEREIRA, J.; LUCENA, E. M. P. Caracterizaçáo de farinha de banana verde. (Characterization of green banana flour) Ciência e Tecnologia de Alimentos, Campinas, (Food Science and Technology) 29(2): 333-339 April-June 2009).

The green banana offers a large amount of starch. The green banana pulp, which can be dehydrated, has around 70 to 80% of starch; this amount can be compared with the one of endosperm vegetables like, for example, potato, and grains such as corn. Therefore, the obtaining green banana flour from the drying of green bananas provides a way of reducing the waste through a manufacturing process with low cost to the food industry. (ZHANG, P.; WHISTLER, R.; BEMILLER, J.; HAMAKER, B. Banana starch: production physicochemical properties and digestibility-a review. Carbohydrate polymers, v. 59, p. 443-58, 2004).

According to the literature, the green banana flour is rich in starch and can contain from 61.3 to 76.5 g/100 g of starch and a fibre content of 6.3 to 15.5 g/100 g, however, much of the starch found in green banana flour is a resistant starch type 2 (RS2), about 52.7 to 54.2 g/100 g, which has attracted interest among researchers due to its positive effects on human colon and other health benefits. (JUAREZ-GARCIA, AGAMA-ACEVEDO, E., SÁYAGO-AYERDI, S. G., RODRÍGUEZ-AMBRIZ, S. L. AND BELLO-PÉREZ, L. A. 2006. Composition, Digestibility and application in breadmaking of banana flour. Plant Foods for Human Nutrition 61:131-137).

This resistant starch, present in the green banana flour, consists of a starch fraction that does not allow the supply of glucose to the body; and resists an enzymatic digestion in the small intestine, which can be fermented in the colon by the microbial flora and produces mainly gas and short chain fatty acids. Due to these characteristics, the RS effects are comparable to the one of the dietary fibre, found in prebiotics. (CHAMP, M.; FAISANT, N. Resistant starch: Analytical and physiological aspects. Boletim SBCTA, v. 30, p. 37-43, 1996).

Similar to the insoluble fibres, the resistant starch helps to regulate the gut work, increasing the stool bulk, reducing gastric emptying and, consequently, preventing intestinal constipation and associated diseases, such as haemorrhoids and diverticulitis, generated by the accumulation of faeces on the intestinal wall, insulin sensitivity, weight loss, decrease in triglycerides and cholesterol. The RS helps people feel more satiated, as well as other types of fibre. (TEKA, A; ZAMAN. Amido resistente, a última geração no controle de energia e digestão saudáve (Resistant starch, the latest generation in the control of energy and healthy digestion) I; 2006).

Moreover, green bananas have low glycemic index which is determined by the speed at which starch is digested, i.e., it has a slow digestion, which decreases the amount of glucose circulating in the blood and prevents excessive insulin release in such a way that this glucose enters the cells; thus, helping to prevent the occurrence of type 2 diabetes. When controlled, glucose also assists in the achieving satiety and in the control of fat accumulation, being important in fighting and treating dyslipidemias, obesity and coronary diseases (CARDENETTE, G. H. L. Produtos derivados de banana verde (‘Musa’ spp.) e sua influência na tolerância à glicose e na fermentação colônica. 2006. Tese (Doutorado em Nutrição Experimental) (Products derived from green bananas (‘Muse’ spp.) and its influence on glucose tolerance and on colonic fermentation. 2006. Thesis (Doctorate's degree Program in Experimental Nutrition)—, —Faculty of Pharmaceutical Sciences, University of So Paulo, Sao Paulo, 2006).

In contrast, cocoa, ingredient used in chocolate production, besides having high levels of fats; it also has anti-nutritional factors such as the methylxanthines which are purine alkaloids that have biological activity. The best-known representatives of this compounds class are: Caffeine, theobromine and theophylline THOMAS, J. B. et al. Determination of caffeine, theobromine, and theophylline in standard reference material 2384, baking chocolate using reverse-phase liquid chromatography. Journal of Agriculture and Food Chemistry, v. 52, n. 11, p. 3259-3263, 2004). Considering theobromine is the substance in the highest quantity.

The importance of methylxanthines comes from the fact that they can have stimulating action on the Central Nervous System (KURIBARA, H. Enhancement of the behavioural toxicity induced by combined administration of ethanol with metilxanthines: evaluation by discrete avoidance in mice. J. Toxicol. Sci., Tokyo, v. 18, n. 2, p. 95-201, 1993.), which may be desirable in some cases, such as in adolescents and young people in school, but may be undesirable in babies and children, causing insomnia and irritation in them, since they are more susceptible. Therefore, it is necessary to control the intake of cocoa products, such as chocolate, chocolate drinks, chocolate biscuits, chocolate bars, among others, especially when it comes to children.

Furthermore, there is a recent interest centred on the reproductive toxicity potential of theobromine, since it crosses the blood-brain barrier and may, supposedly, induce malformation of the embryo, affecting vital genes during development. The developing foetus would not develop enzymes for detoxification of this methylxanthine. For this and other reasons, the presence of theobromine in cocoa limits its potential as nutritious food. (ETENG, M. U.; EYONG, E. U.; AKPANYUNG, E. O.; AGIANG, M. A.; ARENU, C. Y. Recent advances in caffeine and theobromine toxicities: a review. Plant Foods Hum. Nutr., Dordrecht, v. 3, p. 231-243, 1997).

Another factor that extends the functionality of the alternative chocolate made from green banana flour is the absence of lactose and sugar. In a study conducted in Brazil, it was concluded that the incidence of cow's milk protein allergy is 2.2% and the prevalence are 5.7% (SPOLIDORO, J. V. et al. Cow's milk protein allergy in children: a survey on features in Brazil. Journal Parenteral and Enteral Nutrition, v. 29, n. 1, p. s. 27, 2005). Regarding lactose intolerance (IL), the incidence in Brazil is 44.11%, considering that the highest number of new cases were found in zero to ten-year-old children, with 23.71% of incidence, occurring in less frequency in above 40-year-old individuals, expressing the lowest percentage in after 60 years old with 6.71%. (PEREIRA FILHO, D.; FURLAN, S. A. Prevalência de intolerância à lactose em função da faixa etária e do sexo: experiência do laboratório Dona Francisca, Joinville (SC) (Prevalence of lactose intolerance in function of age group and sex: Dona Francisca Laboratory experience, Joinville (SC) Revista Saúde e Ambiente,

### Joinville, v. 5, n. 1, p. 24-30, 2004).

When it comes to the use of sugar, a study conducted a survey regarding the nutritional recommendations on sugar consumption, contained in specialized worldwide publications in three decades, concluding that 84.5% of the analyzed publications, make recommendations on the use of extrinsic or free sugars (they are outside the cellular structure of foods), having consensus that these sugars, especially sucrose, must be significantly reduced from the diet. Such recommendations are generally addressed to the whole population in order to maintain overall health, but, above all, prevent dental cavities and obesity; showing consistency with the scientific evidence of the relationship between sugars and chronic diseases and, therefore, should be integrated into the food and health policies. (FREIRE, M. C. M., CANNON, G., SHEIHAM, B. Análise das recomendações internacionais sobre o consumo de açúcares publicadas entre 1961 a 1991. Revista de Saúde Pública, São Paulo, 1991 (Analysis of international recommendations on sugar intake published between 1961 to 1991). v. 28, n. 3, p. 228-237, 1994).

### THE TECHNIQUE STATE

Consulting patent databases in order to obtaining documents about the proposed object, requests related to processes of obtaining the green banana flour were found, such as the documents BRPI 0901401-2 (Brandão), BRPI 0802523-1 (Silva), BRPI 0705778-4 (USP—Univ. of Sao Paulo) and ES 218791.

Other documents are related to the production of green banana biomass to be incorporated into general foods, such as, for example, the document BRPI 0600998-0 (Valle).

Another document of number BR PI 0903673-3 (Fund. Univ. de Brasilia) refers to a gluten free food product, made from green bananas flour destined for human consumption in general, which may be considered a food for special purposes such as diets with food restriction of gluten.

Another document of number BR 10 2012 031658-7 (Teixeira) refers to the technology needed for obtaining cookie-type biscuit with green banana flour and coconut oil for healthy individual meals; especially children and adolescents, whose meals are low in fibre and high in fat.

As noted, several documents involve the production or products that use, in its composition, green banana flour; however, none of these documents anticipates the features once required, which makes the object of this request new and endowed with inventive activity.

### Technical Problem to be Solved

Therefore, it is clear that there is still need to develop a product that replaces the chocolate made from cocoa with ingredients that provide benefits to human health. The present chocolate composition, said to be alternative, makes this final product a unique product in the market, serving an audience that prioritizes the meal as a factor of improvement in the quality of life.

### Goals of the Invention

It is an objective of the present invention, the formulation of an optional food, chocolate-type alternative, obtained from green bananas flour (Musa spp) derived from green or semi green bananas from the plant varieties Prata, Terra, Cavendish, Nanica or Nanição.

It is another goal of the present invention to obtain an optional food, chocolate-type alternative, which features the absence of lactose, sugar and cocoa.

It is another aim of the present invention to obtain an optional food, alternative chocolate-type, which has, in the green banana flour composition, resistant starch “AR” and dietary fibre “FA” providing a preventive action for some non-communicable chronic diseases.

### DETAILED DESCRIPTION OF THE INVENTION

The present invention refers to “FORMULATION OF FOOD PRODUCT BASED ON GREEN BANANA FLOUR, PRODUCTION PROCESS AND ITS CORRESPONDING END PRODUCT”, this formulation is related to an optional food, chocolate-type alternative, obtained from green banana flour (Musa spp) derived from green or semi green bananas from the plant varieties Prata, Terra, Cavendish, Nanica or Nanição.

The formulation for obtaining an alternative food, object of the present patent presents the following composition: (1) 5 to 60% of Green Banana Flour; (2) 25 to 45% of Palm kernel fat; (3) 8 to 50% of Natural maltitol sweetener; (4) 4 to 35% of Soybean protein extract; (5) 2 to 15% Sucralose artificial sweetener; (6) 1 to 5% Carob powder; (7) 0 to 0.5% of Soy lecithin emulsifier; (8) 0 to 0.1% of Polyglycerol polyricinoleate (PGPR); (9) 0.03 to 0.1% of Natural vanilla flavour; (10) 0.03 to 0.1% of Natural hazelnut flavouring.

Having described the present invention, it must be understood that it may undergo numerous modifications and variations in the components presented in the composition, as it can be seen below:
Item (2)—25 to 45% of Palm fat or 25 to 45% of Coconut fat or 25 to 45% of Hydrogenated vegetable fat;
Item (4)—4 to 30% of Rice protein extract or 4 to 30% of Pea protein extract;
Item (6)—1 to 3% of Carob powder or 1 to 3% of Caramel colouring or 1 to 3% of black plum flour;
Item (10)—0.03 to 0.1% of Natural nuts flavour.

Therefore, the formulation and nutritional information expressed on 100 g of product for the alternative chocolate made from green banana flour, were: Palm kernel Fat 31.340 g; Natural maltitol sweetener 27.787 g; Soybean protein extract 14.150 g; Sucralose artificial sweetener 13.210 g; Green banana flour 9.840 g; Carob powder 2,910 g; Soy lecithin emulsifier 0.480 g; Polyglycerol polyricinoleate (PGPR) 0.100 g; Natural vanilla flavour 0.098 g; Natural hazelnut flavouring 0.085 g.

### Nutritional Information of Alternative Chocolate-Type Product

| | Quantity Per Portion | | % VD |
|---|---|---|---|
| Carbohydrates, of which: | 56 | g | 20% |
| Sugar | 0 | g | — |
| Lactose | 0 | g | — |
| Polyols | 39.2 | g | — |
| Others | 16 | g | — |
| Protein | 4.8 | g | 8% |
| Total Fat | 31.6 | g | 56% |
| Saturated fat | 18 | g | 80% |
| Trans fats | 0 | g | ** |
| Dietary fibre | 2.8 | g | 12% |
| Sodium | 3.2 | mg | 4% |

| | | |
|---|---|---|
| Energy value | 555.5 kcal = 1948 kJ | 24% |

*Daily values based on a 2000 kcal or 8400 kJ diet. Values can be higher or lower depending on the energy needs.
** DV not established.

The chocolate-like alternative food production process, based on green banana flour, comprises the following steps:

Step 1) Initially, the palm kernel fat is weighed and placed into the mixer, that consists of an enclosed tank set for a water bath at 60° C., until it reaches a liquid texture;
Step 2) The following ingredients are weighed and placed in a ball mill (grinder) for 15 minutes: green banana flour, carob powder, soybean protein extract, soy lecithin emulsifier, natural maltitol sweetener, sucralose artificial sweetener, polyglycerol polyricinoleate (PGPR), natural vanilla flavour and natural hazelnut flavouring, where the particles will go through a refining process, decreasing its size;
Step 3) The ingredients that went through the refining process are added to melted fat in the mixer. Attached to the mixer, a suction pump sucks the mixture obtained into a homogenizer, where the ingredients are compressed; this mass returns to the mixer and from there again into the homogenizer. This process takes from 2 to 3 hours, resulting in a liquid and creamy mass with perfect texture and brightness and acquiring the characteristic flavour and aroma of chocolate; and
Step 4) The liquid mass is ready for moulding, made in specific ways, placed on vibrating conveyor belts that eliminate air bubbles within the mass.
Step 4.1) the mass is distributed in moulds to get the desired shape;
Step 4.2) it is taken to a cooling tunnel by a conveyor belt in constant vibration, so that it gets smooth and without any air bubbles;
Step 4.3) once solidified, the chocolate retracts and can be removed from the moulds.

### Tests Based on Formulation Variations

In order to get the best food product in the form of a chocolate-type alternative, made from green banana flour, the following tests were carried out with some formulations:

### Test 1

A mixture with the following ingredients was made: 25% of palm kernel fat, 62% of green banana flour, 10% of maltitol sweetener, 25% of soybean extract, 3% of sucralose sweetener, 3% of carob powder, 0.3% of soy lecithin, 0.08% of polyglycerol polyricinoleate, 0.09% of vanilla flavour and 0.08% of hazelnut flavouring. From this mixture a product with low palatability, strong soybean aroma, astringent taste and little sweet was obtained, disapproved by the tasters.

### Test 2

A mixture with the following ingredients was made: 45% of palm kernel fat, 5% of green banana flour, 12% of maltitol sweetener, 20% of soybean extract, 13% of sucralose sweetener, 1% of carob powder, 0.3% of soy lecithin, 0.1% de of polyglycerol polyricinoleate, 0.1% of vanilla flavour and 0.1% of hazelnut flavouring. From this mixture, a product with little resemblance to chocolate was obtained, with strong soy and fat aroma, without astringency, slightly sweet, light-coloured, sticky texture and slightly soluble in the mouth, disapproved by the tasters.

### Test 3

A mixture with the following ingredients was made: 30% de of palm kernel fat, 10% of green banana flour, 30% of maltitol sweetener, 15% of soybean extract, 13% of sucralose sweetener, 3% of carob powder, 0.5% of soy lecithin, 0.1% of polyglycerol polyricinoleate, 0.1% of vanilla flavour e 0.1% of hazelnut flavouring. From this mixture, a product with good palatability was obtained, showing colour and brightness typical of chocolate, with nice flavour, aroma and texture, approved by the tasters.

It is certain that when the present invention is put into practice, modifications regarding certain manufacturing and shape details can be introduced; without moving away from the fundamental principles that are clearly substantiated in the claiming context, thus, being understood that there was no purpose of limitation by the terminology employed.

1) “FORMULATION OF FOOD PRODUCT BASED ON GREEN BANANA FLOUR, PRODUCTION PROCESS AND ITS CORRESPONDING END PRODUCT”, characterized for the formulation be related to an optional food, chocolate-type alternative, whose composition comprises: (1) 5 to 60% of green banana flour; (2) 25 to 45% of palm kernel fat; (3) 8 to 50% Of Maltitol natural sweetener; (4) 4 to 35% Of Soy Protein Extract; (5) 2 to 15% Artificial sweetener sucralose; (6) 1 to 5% Carob powder; (7) 0 to 0.5% of soy lecithin emulsifier; (8) 0 to 0.1% Polyglycerol polyiricoleate (PGPR); (9) 0.03 to 0.1% of natural vanilla aroma; (10) 0.03 to 0.1% of natural hazelnut flavour.

2) “FORMULATION OF FOOD PRODUCT”, according to claim 1 and an alternative option, characterized by the fact that the Palm kernel fat component can be replaced by 25 to 45% of Palm fat.

3) “FORMULATION OF FOOD PRODUCT”, according to claim 1 and an alternative option, characterized by the fact that the Palm kernel fat component can be replaced by 25 to 45% of Coconut fat.

4) “FORMULATION OF FOOD PRODUCT”, according to claim 1 and an alternative option, characterized by the fact that the Palm kernel fat component can be replaced by 25 to 45% of Hydrogenated vegetable fat.

5) “FORMULATION OF FOOD PRODUCT”, according to claim 1 and an alternative option, characterized by Protein soybean extract component that can be replaced by 4 to 30% of Protein Rice Extract.

6) “FORMULATION OF FOOD PRODUCT”, according to claim 1 and an alternative option, characterized by Protein soybean extract component that can be replaced by 4 to 30% of Protein Pea Extract.

7) “FORMULATION OF FOOD PRODUCT”, according to claim 1 and an alternative option, characterized by Protein soybean extract component that can be replaced by 1 to 3% of Carob powder.

8) “FORMULATION OF FOOD PRODUCT”, according to claim 1 and an alternative option, characterized by Protein soybean extract component that can be replaced by 1 to 3% of Caramel colouring

9) “FORMULATION OF FOOD PRODUCT”, according to claim 1 and an alternative option, characterized by Natural hazelnut flavouring component which can be replaced by 0.03 to 0.1% of Natural Nut flavouring.

10) “FORMULATION OF FOOD PRODUCT”, characterized by the formulation of an optional food, alternative chocolate-type, obtained from the green banana flour, described in claim 1, comprises the following steps:
Step 1) Initially, the palm kernel fat is weighed and placed into the mixer, that consists of an enclosed tank set for a water bath at 60° C., until it reaches a liquid texture;
Step 2) The following ingredients are weighed and placed in a ball mill (grinder) for 15 minutes: green banana flour, carob powder, soybean protein extract, soy lecithin emulsifier, natural maltitol sweetener, sucralose artificial sweetener, polyglycerol polyricinoleate (PGPR), natural vanilla flavour and natural hazelnut flavouring, where the particles will go through a refining process, decreasing its size;
Step 3) The ingredients that went through the refining process are added to melted fat in the mixer, attached to the mixer, a suction pump sucks the mixture obtained into a homogenizer, where the ingredients are compressed; this mass returns to the mixer and from there again into the homogenizer; this process takes from 2 to 3 hours, resulting in a liquid and creamy mass with perfect texture and brightness and acquiring the characteristic flavour and aroma of chocolate; and
Step 4) The liquid mass is ready for moulding, made in specific ways, placed on vibrating conveyor belts that eliminate air bubbles within the mass.
Step 4.1) the mass is distributed in moulds to get the desired shape;
Step 4.2) It is taken to a cooling tunnel by a conveyor belt in constant vibration, so that it gets smooth and without any air bubbles;
Step 4.3) Once solidified, the chocolate retracts and can be removed from the moulds.

11) “FOOD PRODUCT”, according to previous claims, characterized for constituting a chocolate-type alternative, obtained from green banana flour (Musa spp) derived from green or semi green bananas from the plant varieties Prata, Terra, Cavendish, Nanica or Nanição.

12) “FOOD PRODUCT”, according to previous claims, characterized for constituting an chocolate-type alternative, obtained from green banana flour to be presented in the form of tablets, bars, chocolates, toppings, etc.

13) “FOOD PRODUCT”, according to previous claims, characterized for constituting 100 g of a product chocolate-type alternative, obtained from green banana flour consisting of: Palm kernel Fat 31.340 g; Natural maltitol sweetener 27.787 g; soybean protein extract 14.150 g; Artificial sweetener sucralose 13.210 g; Green banana flour 9.840 g; Carob powder 2.910 g; Soy lecithin emulsifier 0.480 g; Polyglycerol polyricinoleate (PGPR) 0.100 g; Natural vanilla flavour 0.098 g; Natural hazelnut flavouring 0.085 g.

14) “FOOD PRODUCT”, according to previous claims, characterized for constituting an alternative chocolate-type product, obtained from green banana flour presenting absence of lactose, sugar and cocoa.
